(19) United States
(12) Patent Application Publication
(10) Pub. No.: US 2017/0363922 A1
(43) Pub. Date: Dec. 21, 2017

(54) LIQUID CRYSTAL DISPLAY PANEL, THE MANUFACTURING METHOD THEREOF AND A DISPLAY APPARATUS

(71) Applicant: Wuhan China Star Optoelectronics Technology Co., Ltd., Wuhan (CN)

(72) Inventor: Yuejun TANG, Shenzhen (CN)

(73) Assignee: Wuhan China Star Optoelectronics Technology Co., Ltd., Wuhan (CN)

(21) Appl. No.: 15/216,650

(22) Filed: Jul. 21, 2016

(30) Foreign Application Priority Data
Jun. 21, 2016 (CN) 2016104551816

(51) Int. Cl. G02F 1/1362; G02F 1/1368; G02F 1/1333; G02F 1/1339

(52) U.S. Cl. CPC G02F 1/136209; G02F 1/13394; G02F 1/136286; G02F 1/1368; G02F 1/133345; G02F 2001/136222; G02F 2201/121; G02F 2201/123; G02F 2001/13396

(57) ABSTRACT

The present application discloses a liquid crystal panel, a manufacturing method thereof and for display apparatus. The liquid crystal panel includes a first substrate, a second substrate and a liquid crystal layer located between the first substrate and the second substrate; a TFT array layer, a color resist layer and an electrode structure layer are formed on the first substrate sequentially; and the color resist layer is formed by a variety of color resist, the color resist layer including a light-shielding region, and a plurality of pixel region, the light-shielding region is in a matrix, the plurality of pixel region is separated by the light-shielding region, each of the pixel region including a kinds of color resist, the light-shielding region is formed by the stacking of a variety of color resist.

### FIELD OF THE INVENTION

The present application relates to liquid crystal display technology field, and more particularly to a liquid crystal display panel the manufacturing method thereof and a display apparatus.

### BACKGROUND OF THE INVENTION

With the extensive application of liquid crystal displays, high-resolution has become the development trend. In order to improve the aperture ratio under the development of high-resolution pixels, the low temperature poly-silicon, LTPS technology has been developed. As shown in FIG. 1, FIG. 1 is a schematic view of a conventional LTPS liquid crystal display panel. The conventional LTPS liquid crystal display panel includes an array substrate 61, and a color filter substrate 62 (CF substrate), spacer (PS) is provided on the CF substrate 62, array substrate 61 has TFT structures 64, a planarization is performed after forming the scanning lines and data lines, a planarization layer 63 is PL, wherein the PL can be a transparent material, such as a transparent resin. A insulating layer 651, common electrode 652, pixel electrode 653 and M3 electrode are formed on the planarization layer 63.

In the production process of this kind of structure of the liquid crystal display panel, in order to ensure the performance of TFT in the LTPS, it usually takes 10 to 12 masks, plus the mask used in the color filter substrate (CF) side, so that the process uses a variety of mask to form the LTPS. Besides, the LTPS often require halftone process in the production of two kinds of PS with two height used as main, sub PS in the CF side. If the three-level PSs are formed in CF-side, the gray tone fabrication is needed to form the PS with three heights respectively, used as main, sub1, and sub2 PS. Therefore, the process of conventional LTPS is complicate, the masks are expensive, and time and material consumption with high production costs.

### SUMMARY OF THE INVENTION

A liquid crystal panel, a manufacturing method thereof and for display apparatus is disclosed in the present application to solve the complicated process and the high production costs issue in the conventional technology.

In order to solve the technology mentioned above, the technology approach adapted by the present application is: a liquid crystal panel is provided, the liquid crystal panel includes a first substrate, a second substrate and a liquid crystal layer located between the first substrate and the second substrate; a TFT array layer, a color resist layer and an electrode structure layer are formed on the first substrate sequentially; and the color resist layer is formed by a variety of color resist, the color resist layer including a light-shielding region, and a plurality of pixel region, the light-shielding region is in a matrix, the plurality of pixel region is separated by the light-shielding region, each of the pixel region including a kinds of color resist, the light-shielding region is formed by the stacking of a variety of color resist.

Wherein the thickness of the light-shielding region is equal to the pixel region to make the surface of the color resist layer planarization Wherein the TFT array layer including a gate line, a data line and a TFT, the gate lines and the data lines are crossing distributed, the TFT is disposed in the space crossed by the gate lines and the data lines;

the electrode structure layer including a common electrode, a pixel electrode and an insulating layer, the common electrode is disposed on the color resist layer, the insulating layer is disposed over the common electrode, the pixel electrode is disposed on the insulating layer.

Wherein a portion of the color resist in the light-shielding region is protruded to form a plurality of support members for supporting the first substrate and the second substrate.

wherein at least two kinds of support member with different height are formed within the plurality of support members.
wherein the cross-sectional area of each of the color resist layer of the support member are gradually decreases from the bottom to the top.
wherein when the first substrate is as the upper substrate, a black matrix is disposed between the first substrate and the TFT array layer and the position of the black matrix is corresponding to the light-shielding region.

In order to solve the technology mentioned above, the technology approach adapted by the present application is providing a display apparatus and the display apparatus including the liquid crystal panel.

In order to solve the technology mentioned above, the technology approach adapted by the present application is providing a manufacturing method for a liquid crystal panel, including the following steps: forming a TFT array layer on the first substrate; a variety of color resist is adapted to form the color resist layer on the TFT array layer, wherein the color resist layer includes light-shielding region, and a plurality of pixel region. The light-shielding region is in a matrix, the plurality of pixel region is separated by the light-shielding region. Each of the pixel region includes a kinds of color resist, the light-shielding region is formed by the stacking of a variety of color resist; forming the electrode structure layer on the color resist layer; and covering the second substrate layer on the electrode structure layer.

Wherein the manufacturing method to forming the color resist layer including:

using the first color resist layer to form the light-shielding region on the TFT array layer, the light-shielding region is distributed in a matrix, the plurality of pixel region is separated by the light-shielding region, at the same time, the first color resist form a first pixel pattern in the predetermined portion of the pixel region of the plurality of the pixel region, and make the thickness of the first pixel pattern is larger than the thickness of the first color resist in the light-shielding region;
a second color resist is adapted to form a second pixel pattern in another predetermined portion of the pixel region of the plurality of the pixel region, at the same time, the second color resist is stacked on the first color resist in the light-shielding region and make the thickness of the second pixel pattern is larger than the thickness of the second color resist in the light-shielding region; a third color resist is adapted to form a third pixel pattern in another predetermined portion of the pixel region of the plurality of the pixel region, at the same time, the third color resist is stacked on the second color resist in the light-shielding region and make the thickness of the third pixel pattern is larger than the thickness of the third color resist in the light-shielding region; and wherein the thickness of the first pixel pattern, the second pixel pattern, the third pixel pattern and the light-shielding region are equal, so that the color resist layer surface is made planarization.

The advantage of the present application is: distinguished form the conventional technology, the present application provides a TFT array layer, a color resist layer and an electrode structure layer formed on the first substrate; and a light-shielding region, and a plurality of pixel region is disposed in the color resist layer, the light-shielding region is formed by the stacking of a variety of color resist of the pixel region. During forming the pixel region by the color resist, the light-shielding region can be formed simultaneously, and no further color resist layer and the black matrix need to be form on the second substrate, thus saving the mask production process, the process is simplified, thus saving material costs and manufacturing time. In addition, since the pixel region, the light-shielding region, TFT array layer and the electrode structure layer are disposed on the first substrate. It can avoid the problem of low accuracy caused due to the deviation in the alignment of the second substrate, thereby improving the accuracy of the alignment, and improving the quality of the product.

### BRIEF DESCRIPTION OF THE DRAWINGS

In order to more clearly illustrate the embodiments of the present application or prior art, the following figures will be described in the embodiments are briefly introduced. It is obvious that the drawings are merely some embodiments of the present application, those of ordinary skill in this field can obtain other figures according to these figures without paying the premise.

FIG. 1 is a schematic view of a conventional LTPS liquid crystal display panel;

FIG. 2 is a schematic view of a liquid crystal panel according to the first embodiment of the present invention;

FIG. 3 a schematic view of a liquid crystal panel according to a situation of the second embodiment of the present invention;

FIG. 4 a schematic view of a liquid crystal panel according to another situation of the second embodiment of the present invention;

FIG. 5 is a schematic view of a liquid crystal panel according to the third embodiment of the present invention;

FIG. 6 is a schematic view of a display apparatus according to the embodiment of the present invention;

FIG. 7 illustrated a process flow of the manufacturing method to form the liquid crystal panel according to the first embodiment of the present invention;

FIG. 8 illustrated a process flow of the manufacturing method to form the liquid crystal panel according to the second embodiment of the present invention;

FIG. 9 illustrated a process flow of S202 illustrated in FIG. 8;

FIG. 10 illustrated a process flow of S2021 illustrated in FIG. 9;

FIG. 11 illustrated a process flow of S2022 illustrated in FIG. 9;

FIG. 12 illustrated a process flow of S2023 illustrated in FIG. 9;

FIG. 13 illustrated a process flow of the manufacturing method to form the liquid crystal panel according to the third embodiment of the present invention; and

FIG. 14 illustrated a process flow of the manufacturing method to form the liquid crystal panel according to the fourth embodiment of the present invention.

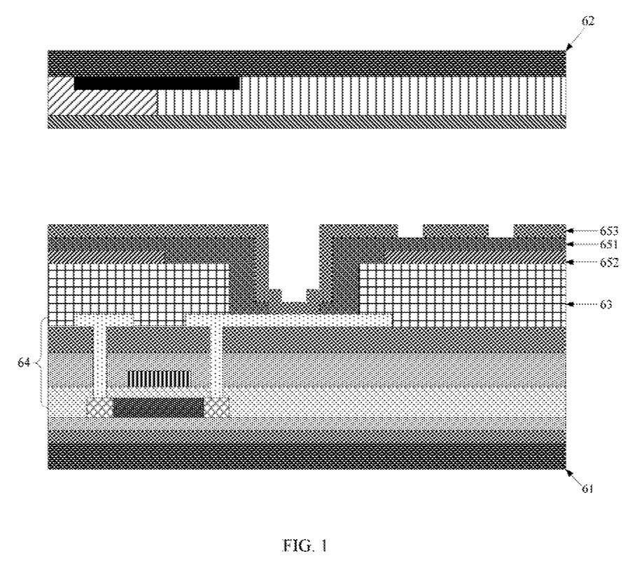

### DETAILED DESCRIPTION OF PREFERRED EMBODIMENTS

Embodiments of the present application are described in detail with the technical matters, structural features, achieved objects, and effects with reference to the accompanying drawings as follows. It is clear that the described embodiments are part of embodiments of the present application, but not all embodiments. Based on the embodiments of the present application, all other embodiments to those of ordinary skill in the premise of no creative efforts obtained should be considered within the scope of protection of the present application.

Specifically, the terminologies in the embodiments of the present application are merely for describing the purpose of the certain embodiment, but not to limit the invention. Examples and the claims be implemented in the present application requires the use of the singular form of the book “an”, “the” and “the” are intend to include most forms unless the context clearly dictates otherwise. It should also be understood that the terminology used herein that “and/or” means and includes any or all possible combinations of one or more of the associated listed items.

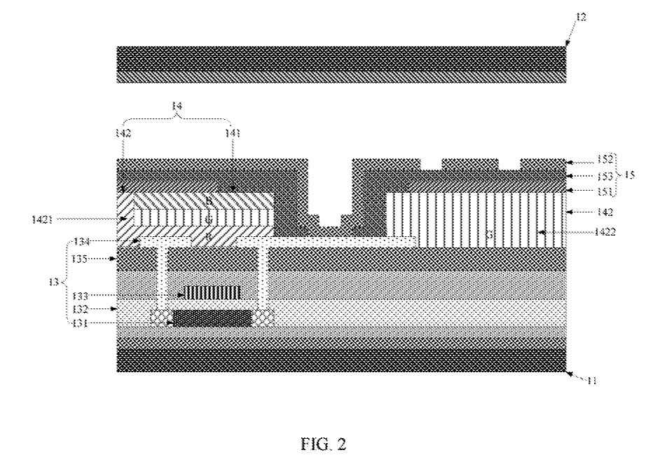

Referring to FIG. 2, is a schematic view of a liquid crystal panel according to the first embodiment of the present invention.

The liquid crystal panel of the present invention includes a first substrate 11, a second substrate 12 and a liquid crystal layer (not shown) located between the first substrate 11 and the second substrate 12.

A TFT array layer 13, a color resist layer 14 and an electrode structure layer 15 are formed on the first substrate 11 sequentially.

The color resist layer 14 is formed by a variety of color resist, the color resist layer 14 includes light-shielding region 141, and a plurality of pixel region 142. The light-shielding region 141 is in a matrix, the plurality of pixel region 142 is separated by the light-shielding region 141. Each of the pixel region 142 includes a kinds of color resist, the light-shielding region 141 is formed by the stacking of a variety of color resist. Wherein the material of the color resist can be photosensitive resin composition with red, green, blue pigments, e.g., chemically amplified photosensitive resin with a phenolic resin as a base resin, and the like.

Distinguished from the conventional technology, the TFT array layer 13, the color resist layer 14 and the electrode structure layer 15 are formed on the first substrate 11 of the present application, and the pixel region 142 and the light-shielding region 141 is set in the color resist layer 14, the light-shielding region 141 is formed by the stacking of the color resist to form the pixel region 142, so that when forming the pixel region 142 by the color resist can also forming the light-shielding region 141 simultaneously. There are no longer color resist layer 13 and the black matrix be formed on the second substrate 12, thereby saving the mask production process, simplifying the process, thus saving material costs and manufacturing time. Further, since the pixel region 142, the light-shielding region 141, the TFT array layer 13 and the electrode structure layer 15 are formed on the first substrate 11. It can avoid the problem of low accuracy caused due to the deviation in the alignment of the second substrate 12, thereby improving the accuracy of the alignment, and improving the quality of the product.

In this embodiment, the light-shielding region 141 is the black matrix (BM). When the first substrate 11 is as the lower substrate, the light-shielding region 141 is used for preventing the light leakage of the backlight, improve the display contrast, and prevent color mixing and increase the color purity.

The thickness of the light-shielding region 141 is equal to the thickness of the pixel region 141 to make the surface of the color resist layer planarization, so as the color resist to form the pixel region 142 can achieve the function of planarization layer and the black matrix simultaneously. For example, the color resist layer of this embodiment includes a red resist (R), green resist (G) and blue resist (B). In the manufacturing process, after coating the red resist, a BM-R portion with a desired height and through holes are formed in the color resist by the use of the Gray tone technology. A BM-G and a BM-B color resist with a desired height are also formed in the subsequent G, B color resist by the use of the Gray tone technology, so that the height of the stacking RGB color resist=the height of the R/G/B color resist.

For example, the TFT array layer 13 of the present embodiment includes a gate line, a data line and a TFT, the gate lines and the data lines are crossing distributed, the TFT is disposed in the space crossed by the gate lines and the data lines. More specifically, the TFT includes a semiconductor pattern layer 131, a gate insulating layer 132, a gate pattern layer 133, a source/drain electrode pattern layer 134 and an interlayer insulating layer 135. Wherein the semiconductor pattern layer 131 is formed on the first substrate 11, the gate insulating layer 132 overlies the semiconductor pattern layer 131, the gate pattern layer 133 is formed on the gate insulating layer 132, the interlayer insulating layer 135 is formed on the gate pattern layer 133, the source/drain electrode pattern layer 134 is formed on the interlayer insulating layer 135. In this embodiment, the interlayer insulating layer 135 is formed of two layers of insulating material, such as SiNₓ and SiO₂. Of course, in other embodiments, the interlayer insulating layer 15 can be formed by an insulating material, such as SiNₓ and SiO₂, or other conventional insulation materials.

The electrode structure layer 15 includes a common electrode 151, a pixel electrode 152 and an insulating layer 153. The common electrode 151 is disposed on the color resist layer 14, the insulating layer 153 is disposed over the common electrode 151, the pixel electrode 152 is disposed on the insulating layer 153.

The color resist layer of the present embodiment includes a red resist (R), a green resist (G) and a blue resist (B). The pixel region formed by the color resist includes a red pixel region 1421, a green pixel region 1422, and a blue pixel region 1423 separately. Of course, in other embodiments, it can further include a white color resist. The stacking order of the color resist in the light-shielding region 141 is in accordance with the manufacturing order of the pixel region 142 sequentially, so when the manufacturing order of the color resist of the pixel region is different, the stacking order of the color resist in the light-shielding region 141 is different. The manufacturing order of the pixel region 142 illustrated in FIG. 2 is red pixel region 1421 to green pixel region 1422 to blue pixel region 1423.

It is worth mentioning that, in the present invention, the red color resist, the green color resist and the blue color resist are located in the red pixel region 1421, the green pixel region 1422, and the blue pixel region 1423 and only stacking in the light-shielding region 141. The pixel distribution is simplified, but in order to facilitate the relationship of the light-shielding region 141 formed by the red color resist, the green color resist and the blue color resist and the planarization layer illustrated in FIG. 2. In addition, a shielding layer is under the semiconductor pattern layer 131 but not shown in FIG. 2 and does not cause interference in the present invention.

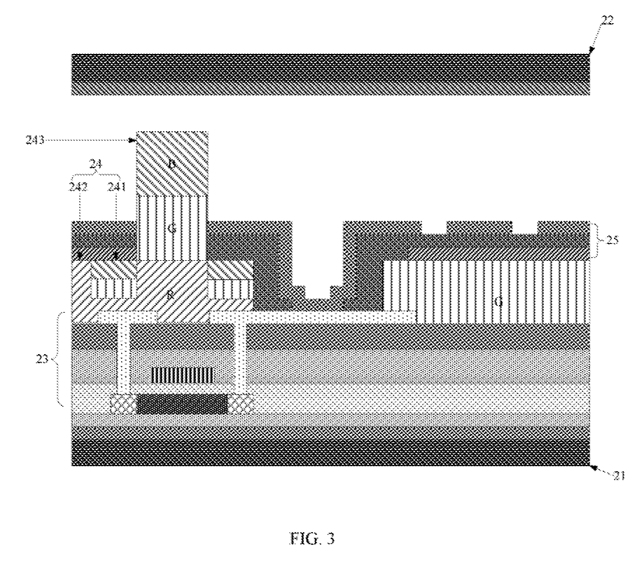

Referring to FIG. 3, FIG. 3 a schematic view of a liquid crystal panel according to a situation of the second embodiment of the present invention.

The liquid crystal panel of the present invention includes a first substrate 21, a second substrate 22 and a liquid crystal layer (not shown) located between the first substrate 21 and the second substrate 22.

A TFT array layer 23, a color resist layer 24 and an electrode structure layer 25 are formed on the first substrate 21 sequentially.

The color resist layer 24 is formed by a variety of color resist, the color resist layer 24 includes light-shielding region 241, and a plurality of pixel region 242. The light-shielding region 241 is in a matrix, the plurality of pixel region 242 is separated by the light-shielding region 241. Each of the pixel region 242 includes a kinds of color resist, the light-shielding region 241 is formed by the stacking of a variety of color resist. Wherein the material of the color resist can be photosensitive resin composition with red, green, blue pigments, e.g., chemically amplified photosensitive resin with a phenolic resin as a base resin, and the like.

The thickness of the light-shielding region 241 is equal to the thickness of the pixel region 241 to make the surface of the color resist layer planarization, so as the color resist to form the pixel region 242 can achieve the function of planarization layer and the black matrix simultaneously.

In this embodiment, a portion of the color resist in the light-shielding region 241 is protruded to form a plurality of support members 243 for supporting the first substrate 21 and the second substrate 22. Wherein each layer of the color resist stacking to form the light-shielding region 241 are protruded in the same site to form the support members 243. When the color resist is using a chemically amplified photosensitive resin such as a phenolic resin as a base resin, which has some flexibility and fit the function to be the support members 243. Wherein the stacking order of the color resist of the support member 243 is according to the manufacturing order of making the pixel region 242. In the case of this embodiment, the height of the plurality of the support members 243 is consistent, therefore FIG. 3 only shows one support member 243.

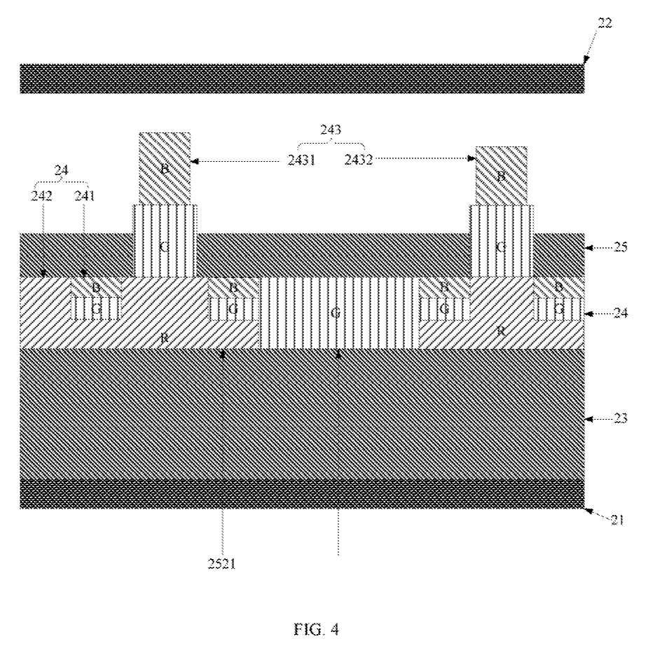

In another case, the plurality of the support members 243 has at least two distinct height of the support member 243. As illustrated in FIG. 4, FIG. 4 a schematic view of a liquid crystal panel according to another situation of the second embodiment of the present invention. The two kinds of support member 243 with different height are illustrated. A first support section 2431 and a second support member 2432 with a height difference are formed by the different color resist with stacking the color resist. The detail manufacturing method are: (1) by the forming process of one or multiple color resist of the color resist layer, the Gray tone technology is adapted to obtain the suitable height of the color resist and during the stacking of the color resist support member with demand height; (2) by controlling the reflow volume after coating (e.g., developing, curing time) of the upper layer of the color resist separately (as the G, B illustrated in FIG. 4) to make the upper layer of the color resist having a predetermined height. (3) by making the different size (area) of the upper layer of the color resist and to have different reflow volume of the first support section 2431 and a second support member 2432, then to obtain the stacking of the B color resist with different height of the first support section 2431 and a second support member 2432 illustrated in FIG. 4.

It is worth mentioning that, as shown in FIG. 4, the cross-sectional area of each of the color resist to form the support member 243 are gradually decreases from the bottom to the top.

In particular, after the formation of the RGB color resist planarization layer, the support member 243 and the through-holes, the top portion of the support member 243 can be selective retained or removed partial or all of these layer structures to obtain the appropriate height of the support member 243 in the production of the insulating layer, the common electrode, the pixel electrode, the M3 electrode, or the like. The insulating layer can be remained in the outer surface of the support member 243 to prevent the support member 243 structure in contact with the liquid crystal. At this time, in order to make the insulating layer, and the alignment film subsequently formed on the side surface of the support member 243 can be formed in a better way, the cross-sectional area of the R color>the cross-sectional area of the G color>the cross-sectional area of the B color of the support member 243 illustrated in FIG. 4, and so that the support member 243 is integrally formed into a circular table (with cross section in trapezoidal).

It should be note that, in order to obtain a suitable cell gap, it can be achieved by the following way: (1) by controlling the transmittance rate of the region to form the support member 243 and the region not to form the support member 243 in the light-shielding region 241 during the exposure, so that the reserved color resist layer in the region of the support member 243 is slightly thinner than the pixel region 242, to obtain a suitable height of the support member 243; (2) by controlling the reflow volume after coating (e.g., developing, curing time) of the upper layer of the color resist separately (as the G, B illustrated in FIG. 4) to make the upper layer of the color resist having a predetermined height and to obtain a suitable height of the support member 243. (3) by making the different size (area) of the upper layer of the color resist and to have different reflow volume to obtain a suitable stacking height of the support member 243.

Referring to FIG. 5, FIG. 5 is a schematic view of a liquid crystal panel according to the third embodiment of the present invention.

The liquid crystal panel of the present invention includes a first substrate 31, second substrate 32 and a liquid crystal layer located between the first substrate 31 and the second substrate 32.

A TFT array layer 33, a color resist layer 34 and an electrode structure layer 35 are formed on the first substrate 31 sequentially. The color resist layer 34 is formed by a variety of color resist, the color resist layer 34 includes light-shielding region 341, and a plurality of pixel region 342. The light-shielding region 341 is in a matrix, the plurality of pixel region 342 is separated by the light-shielding region 341. Each of the pixel region 342 includes a kinds of color resist, the light-shielding region 341 is formed by the stacking of a variety of color resist.

When the first substrate 31 is as the upper substrate, a black matrix 36 is disposed between the first substrate 31 and the TFT array layer 33. The position of the black matrix 36 is corresponding to the light-shielding region 341. In this embodiment, the light-shielding region 341 is used to shield the influence of light from the backlight to the semiconductor pattern layer, and the black matrix 36 is used to shield the influence of external ambient light to the semiconductor pattern layer.

Specifically, the black matrix 36 can be formed by metallic chromium, of course, in other embodiments, the black matrix 36 can be formed by black resin (resin with C, Ti, Ni and other black materials) or can be formed by other materials commonly used in the technology.

In this embodiment, the aperture region of the pixel is formed by one of the black matrix 36 or the light-shielding region 341 or formed by both of them. In one embodiment, the aperture region of the pixel is formed by the black matrix 36, and the light-shielding region 341 is formed below the TFT structure to shield the influence of light from the backlight to the semiconductor pattern layer.

The areas of the black matrix 36 and the light-shielding region 341 can include the following three cases: (1) the region of the light-shielding region 341 is smaller than the area of the black matrix 36 is formed, so that the light-shielding region 341 is inside the area of the black matrix 36; (2) the region of the light-shielding region 341 is equal and overlap to the black matrix 341; (3) the region of the black matrix 36 is smaller than the area of the light-shielding region 341 is formed, so that the black matrix 36 is inside the area of the light-shielding region 341.

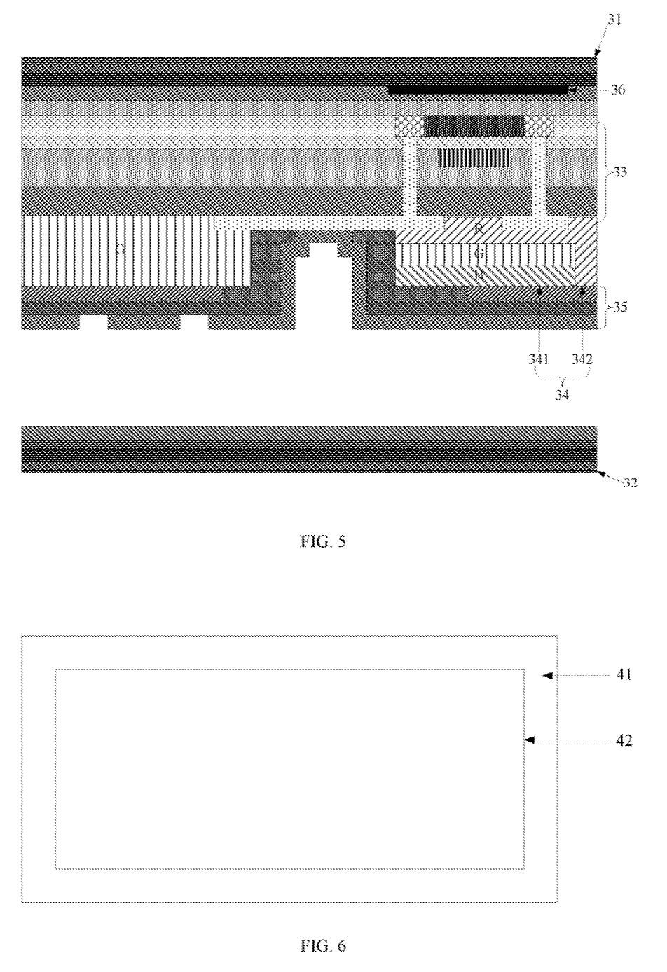

Referring to FIG. 6, FIG. 6 is a schematic view of a display apparatus according to the embodiment of the present invention;

The present invention also provides a display apparatus, which includes a housing 41 and a liquid crystal panel 42 of any of the above embodiments.

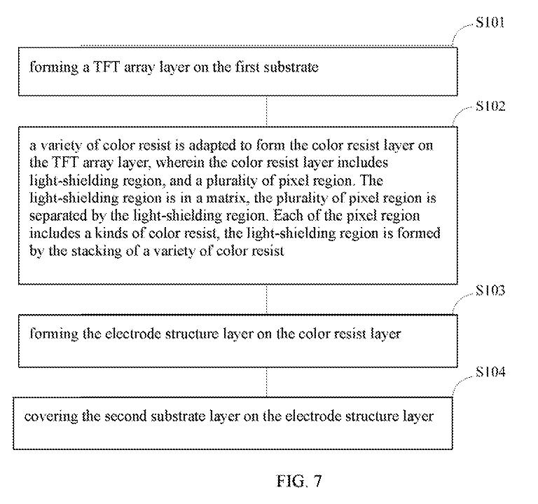

Referring to FIG. 7, FIG. 7 illustrated a process flow of the manufacturing method to form the liquid crystal panel according to the first embodiment of the present invention.

The present invention also provides a manufacturing method to form the liquid crystal panel, the manufacturing method including the steps of:

S101, forming a TFT array layer on the first substrate.

In step S101, the formed TFT array layer includes gate line, data line and TFT, the gate lines and the data lines are crossing distributed, the TFT is disposed in the space crossed by the gate lines and the data lines. More specifically, the detail manufacturing process of the TFT includes: forming a semiconductor pattern layer on the first substrate, covering a gate insulating layer on the semiconductor pattern layer, forming a gate pattern layer on the gate insulating layer, forming an interlayer insulating layer on the gate pattern layer and forming a source/drain electrode pattern layer on the interlayer insulating layer.

S102: a variety of color resist is adapted to form the color resist layer on the TFT array layer, wherein the color resist layer includes light-shielding region, and a plurality of pixel region. The light-shielding region is in a matrix, the plurality of pixel region is separated by the light-shielding region. Each of the pixel region includes a kinds of color resist, the light-shielding region is formed by the stacking of a variety of color resist.

For example, the variety of color resist include the red color resist, the green color resist and the blue color resist. The pixel region includes the red pixel region formed by the red color resist, the green pixel region formed by the green color resist, and the blue pixel region formed by the blue color resist, and the light-shielding region is formed by the stacking of the red color resist, the green color resist and the blue color resist.

S103: forming the electrode structure layer on the color resist layer.

Wherein the step of forming the electrode structure layer includes: forming the common electrode on the color resist layer, covering an insulating layer on the common electrode, forming the pixel electrode on the insulating layer.

S104: covering the second substrate layer on the electrode structure layer.

The step S104 is a cartridge process, that is to assemble the second substrate to the first substrate with elements to form a liquid crystal panel.

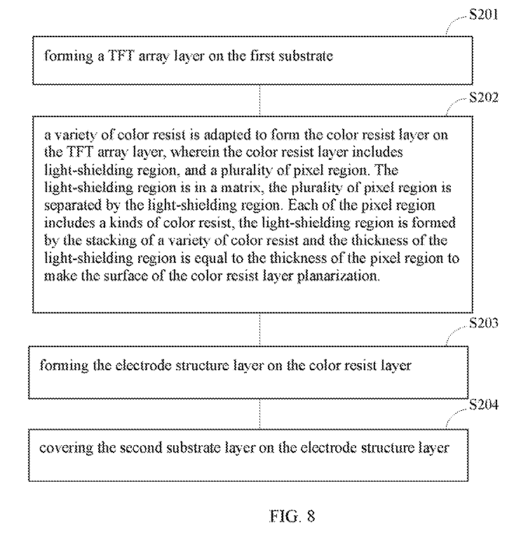

Referring to FIG. 8, FIG. 8 illustrated a process flow of the manufacturing method to form the liquid crystal panel according to the second embodiment of the present invention.

S201, forming a TFT array layer on the first substrate.

S202: a variety of color resist is adapted to form the color resist layer on the TFT array layer, wherein the color resist layer includes light-shielding region, and a plurality of pixel region. The light-shielding region is in a matrix, the plurality of pixel region is separated by the light-shielding region. Each of the pixel region includes a kinds of color resist, the light-shielding region is formed by the stacking of a variety of color resist and the thickness of the light-shielding region is equal to the thickness of the pixel region to make the surface of the color resist layer planarization.

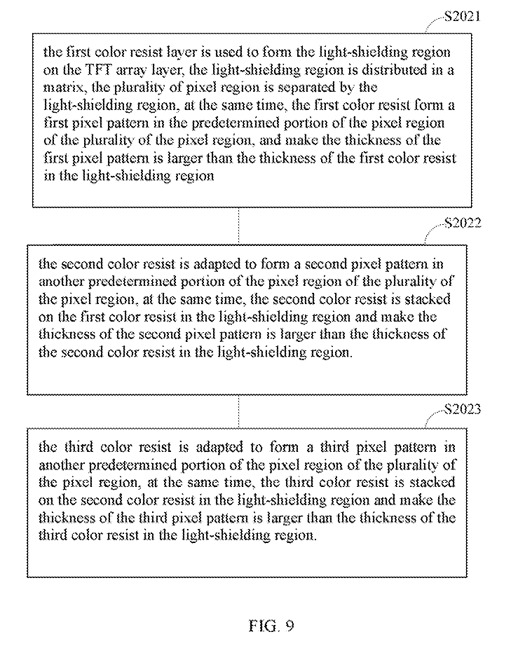

Referring to FIG. 9, FIG. 9 illustrated a process flow of S202 illustrated in FIG. 8.

Specifically, step S202 includes the steps of:

S2021, the first color resist layer is used to form the light-shielding region on the TFT array layer, the light-shielding region is distributed in a matrix, the plurality of pixel region is separated by the light-shielding region, at the same time, the first color resist form a first pixel pattern in the predetermined portion of the pixel region of the plurality of the pixel region, and make the thickness of the first pixel pattern is larger than the thickness of the first color resist in the light-shielding region.

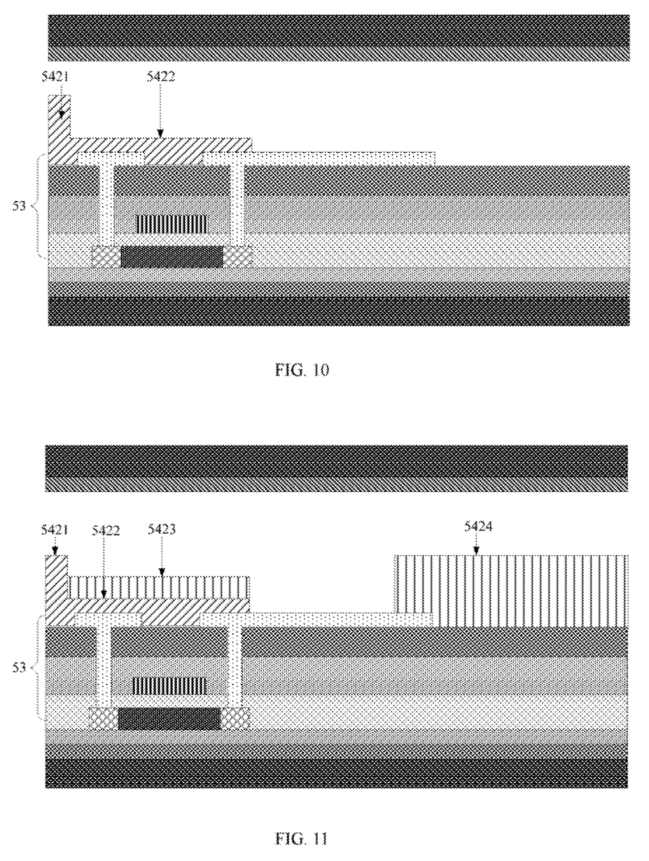

As illustrated in FIG. 10, FIG. 10 illustrated a process flow of S2021 illustrated in FIG. 9. The first color resist is red color resist. After coating the red color resist on the TFT array layer 53, a red pixel pattern 5421, BM-R portion 5422 with a desired height and through holes are simultaneously formed in the color resist by the use of the Gray tone technology. In particular, the thickness of the red pixel pattern is greater than the thickness of the BM-R portion 5422.

S2022, the second color resist is adapted to form a second pixel pattern in another predetermined portion of the pixel region of the plurality of the pixel region, at the same time, the second color resist is stacked on the first color resist in the light-shielding region and make the thickness of the second pixel pattern is larger than the thickness of the second color resist in the light-shielding region.

Referring to FIG. 11, FIG. 11 illustrated a process flow of S2022 illustrated in FIG. 9. The second color resist is green color resist. After coating the green color resist on the TFT array layer 53 and the red color resist on the light-shielding region, a green pixel pattern 5424, BM-G portion 5423 with a desired height and through holes are simultaneously formed in the color resist by the use of the Gray tone technology. In particular, the thickness of the green pixel pattern 5424 is greater than the thickness of the BM-G portion 5423.

S2023, the third color resist is adapted to form a third pixel pattern in another predetermined portion of the pixel region of the plurality of the pixel region, at the same time, the third color resist is stacked on the second color resist in the light-shielding region and make the thickness of the third pixel pattern is larger than the thickness of the third color resist in the light-shielding region.

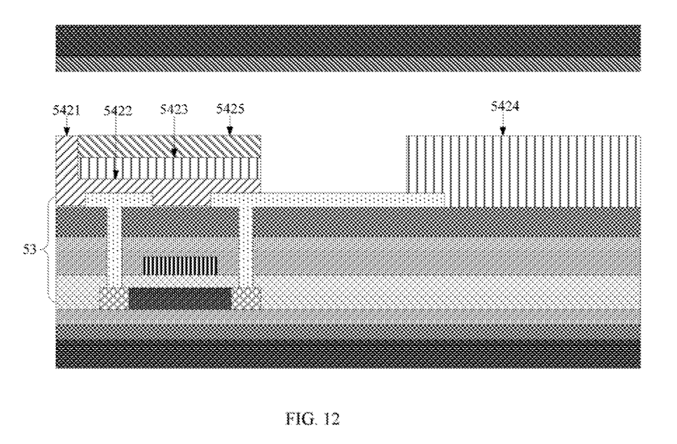

Referring to FIG. 12, FIG. 12 illustrated a process flow of S2023 illustrated in FIG. 9. The third color resist is blue color resist. After coating the blue color resist on the TFT array layer 53 and the green color resist on the light-shielding region, a blue pixel pattern, BM-B portion 5425 with a desired height and through holes are simultaneously formed in the color resist by the use of the Gray tone technology. In particular, the thickness of the blue pixel pattern is greater than the thickness of the BM-B portion 5425.

Wherein the thickness of the first pixel pattern, the second pixel pattern, the third pixel pattern and the light-shielding region are equal, so that the color resist layer surface is make planarization.

In this embodiment, the thickness of the red pixel pattern finally formed, the green pixel pattern, and the blue pixel pattern is equal to the thickness of the light-shielding region stacking by the R-G-B color resist.

of the light shielding region and the thickness of the blue pixel patterns stacked to form the same.

S203: forming the electrode structure layer on the color resist layer.

S204: covering the second substrate layer on the electrode structure layer.

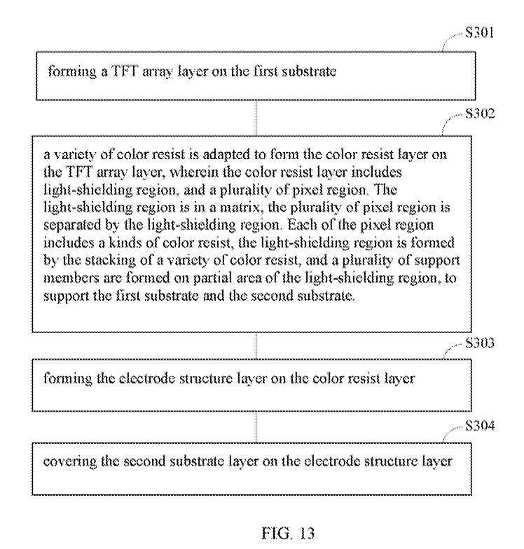

Referring to FIG. 13, FIG. 13 illustrated a process flow of the manufacturing method to form the liquid crystal panel according to the third embodiment of the present invention.

S301, forming a TFT array layer on the first substrate.

S302: a variety of color resist is adapted to form the color resist layer on the TFT array layer, wherein the color resist layer includes light-shielding region, and a plurality of pixel region. The light-shielding region is in a matrix, the plurality of pixel region is separated by the light-shielding region. Each of the pixel region includes a kinds of color resist, the light-shielding region is formed by the stacking of a variety of color resist, and a plurality of support members are formed on partial area of the light-shielding region, to support the first substrate and the second substrate.

For example, the formation method of the support member: after coating the red color resist on the TFT array layer, a red pixel pattern, a BM-R portion with a desired height and through holes are simultaneously formed in the color resist by the use of the Gray tone technology. And a support member is formed in a preset position, for example, the thickness of the red color resist in the portion of the support member in the light-shielding region is equal to the thickness of the red pixel pattern by the use of the Gray tone technology. And the thickness of the other portion of the light-shielding region is smaller than the thickness of the support member. The manufacturing process of the green color resist and the blue resist is the same, so that the thickness of the red color resist to form the stacked support member is equal to the thickness of the red pixel pattern, the thickness of the green color resist to form the stacked support member is equal to the thickness of the green pixel pattern, and the thickness of the blue color resist to form the stacked support member is equal to the thickness of the blue pixel pattern.

It is worth mentioning that, in other embodiments, the thickness of the red color resist to form the stacked support member is larger than the thickness of the red color resist in the other region of the light-shielding region, and not equal to the thickness of the red pixel pattern; the thickness of the green color resist to form the stacked support member is larger than the thickness of the green color resist in the other region of the light-shielding region, and not equal to the thickness of the green pixel pattern; the thickness of the blue color resist to form the stacked support member is larger than the thickness of the blue color resist in the other region of the light-shielding region, and not equal to the thickness of the blue pixel pattern.

In addition, in one condition of the present embodiment, the height of the plurality of support members are the same. In another case, at least two kinds of support member with different height are in the plurality of support members. The detail manufacturing method are: (1) by the forming process of one or multiple color resist of the color resist layer, the Gray tone technology is adapted to obtain the suitable height of the color resist and during the stacking of the color resist support member with demand height; (2) by controlling the reflow volume after coating (e.g., developing, curing time) of the upper layer of the color resist separately (as the G, B illustrated in FIG. 4) to make the upper layer of the color resist having a predetermined height. (3) by making the different size (area) of the upper layer of the color resist and to have different reflow volume of the first support section and a second support member, then to obtain the stacking of the B color resist with different height of the first support section and a second support member illustrated in FIG. 4.

In particular, after the formation of the RGB color resist planarization layer, the support member and the through-holes, the top portion of the support member can be selective retained or removed partial or all of these layer structures to obtain the appropriate height of the support member in the production of the insulating layer, the common electrode, the pixel electrode, the M3 electrode, or the like. The insulating layer can be remained in the outer surface of the support member to prevent the support member structure in contact with the liquid crystal. At this time, in order to make the insulating layer, and the alignment film subsequently formed on the side surface of the support member can be formed in a better way, the cross-sectional area of the R color>the cross-sectional area of the G color>the cross-sectional area of the B color of the support member illustrated in FIG. 4, and so that the support member is integrally formed into a circular table (with cross section in trapezoidal).

It should be note that, in order to obtain a suitable cell gap, it can be achieved by the following way: (1) by controlling the transmittance rate of the region to form the support member and the region not to form the support member in the light-shielding region during the exposure, so that the reserved color resist layer in the region of the support member is slightly thinner than the pixel region, to obtain a suitable height of the support member; (2) by controlling the reflow volume after coating (e.g., developing, curing time) of the upper layer of the color resist separately (as the G, B illustrated in FIG. 4) to make the upper layer of the color resist having a predetermined height and to obtain a suitable height of the support member. (3) by making the different size (area) of the upper layer of the color resist and to have different reflow volume to obtain a suitable stacking height of the support member.

S303: forming the electrode structure layer on the color resist layer.

S304: covering the second substrate layer on the electrode structure layer.

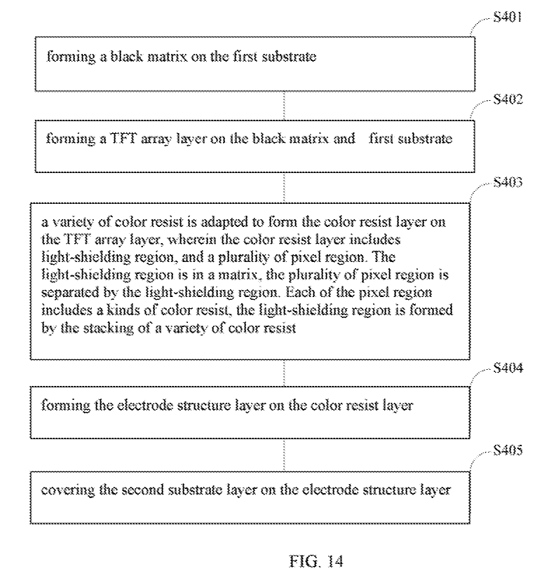

Referring to FIG. 14, FIG. 14 illustrated a process flow of the manufacturing method to form the liquid crystal panel according to the fourth embodiment of the present invention.

S401, forming a black matrix on the first substrate.

Specifically, the black matrix can be formed by metallic chromium, of course, in other embodiments, the black matrix 36 can be formed by black resin (resin with C, Ti, Ni and other black materials) or can be formed by other materials commonly used in the technology. The black matrix is used to shield the influence of external ambient light to the semiconductor pattern layer.

S402: a TFT array layer is formed on the black matrix and the first substrate.

S403: a variety of color resist is adapted to form the color resist layer on the TFT array layer, wherein the color resist layer includes light-shielding region, and a plurality of pixel region. The light-shielding region is in a matrix, the plurality of pixel region is separated by the light-shielding region. Each of the pixel region includes a kinds of color resist, the light-shielding region is formed by the stacking of a variety of color resist.

In particular, the aperture region of the pixel is formed by one of the black matrix or the light-shielding region or formed by both of them. In one embodiment, the aperture region of the pixel is formed by the black matrix, and the light-shielding region is formed below the TFT structure to shield the influence of light from the backlight to the semiconductor pattern layer.

The areas of the black matrix and the light-shielding region can include the following three cases: (1) the region of the light-shielding region is smaller than the area of the black matrix is formed, so that the light-shielding region is inside the area of the black matrix; (2) the region of the light-shielding region is equal and overlap to the black matrix; (3) the region of the black matrix is smaller than the area of the light-shielding region is formed, so that the black matrix is inside the area of the light-shielding region.

S404: forming the electrode structure layer on the color resist layer.

S405: covering the second substrate layer on the electrode structure layer.

In summary, the present invention can simplify the process, saving material costs and manufacturing time, and can improve the accuracy of the cartridge, thereby improving the quality of the product.

Above are embodiments of the present application, which does not limit the scope of the present application. Any modifications, equivalent replacements or improvements within the spirit and principles of the embodiment described above should be covered by the protected scope of the invention.

1. A liquid crystal panel, comprising: a first substrate, a second substrate and a liquid crystal layer located between the first substrate and the second substrate;
a TFT array layer, a color resist layer and an electrode structure layer are formed on the first substrate sequentially; and
the color resist layer is formed by a variety of color resist, the color resist layer comprising a light-shielding region, and a plurality of pixel region, the light-shielding region is in a matrix, the plurality of pixel region is separated by the light-shielding region, each of the pixel region comprising a kinds of color resist, the light-shielding region is formed by stacking the first color resist as L shape then stacking the other color resists.

2. The liquid crystal panel according to claim 1, wherein the thickness of the light-shielding region is equal to the pixel region to make the surface of the color resist layer planarization.

3. The liquid crystal panel according to claim 2, wherein the TFT array layer comprising a gate line, a data line and a TFT, the gate lines and the data lines are crossing distributed, the TFT is disposed in the space crossed by the gate lines and the data lines;
the electrode structure layer comprising a common electrode, a pixel electrode and an insulating layer, the common electrode is disposed on the color resist layer, the insulating layer is disposed over the common electrode, the pixel electrode is disposed on the insulating layer.

4. The liquid crystal panel according to claim 1, wherein a portion of the color resist in the light-shielding region is protruded to form a plurality of support members for supporting the first substrate and the second substrate.

5. The liquid crystal panel according to claim 4, wherein at least two kinds of support member with different height are formed within the plurality of support members.

6. The liquid crystal panel according to claim 5, wherein the cross-sectional area of each of the color resist layer of the support member are gradually decreases from the bottom to the top.

7. The liquid crystal panel according to claim 3, wherein when the first substrate is as the upper substrate, a black matrix is disposed between the first substrate and the TFT array layer and the position of the black matrix is corresponding to the light-shielding region.

8. A display apparatus, including the liquid crystal panel according to claim 1.

9. A manufacturing method for a liquid crystal panel, including the following steps:
forming a TFT array layer on the first substrate;
a variety of color resist is adapted to form the color resist layer on the TFT array layer, wherein the color resist layer includes light-shielding region, and a plurality of pixel region; the light-shielding region is in a matrix, the plurality of pixel region is separated by the light-shielding region. Each of the pixel region includes a kinds of color resist, the light-shielding region is formed by stacking the first color resist as L shape then stacking the other color resists;
forming the electrode structure layer on the color resist layer; and
covering the second substrate layer on the electrode structure layer.

10. The manufacturing method for a liquid crystal panel according to claim 9, wherein the manufacturing method to forming the color resist layer including:
using the first color resist layer to form the light-shielding region on the TFT array layer, the light-shielding region is distributed in a matrix, the plurality of pixel region is separated by the light-shielding region, at the same time, the first color resist form a first pixel pattern in the predetermined portion of the pixel region of the plurality of the pixel region, and make the thickness of the first pixel pattern is larger than the thickness of the first color resist in the light-shielding region;
a second color resist is adapted to form a second pixel pattern in another predetermined portion of the pixel region of the plurality of the pixel region, at the same time, the second color resist is stacked on the first color resist in the light-shielding region and make the thickness of the second pixel pattern is larger than the thickness of the second color resist in the light-shielding region;
a third color resist is adapted to form a third pixel pattern in another predetermined portion of the pixel region of the plurality of the pixel region, at the same time, the third color resist is stacked on the second color resist in the light-shielding region and make the thickness of the third pixel pattern is larger than the thickness of the third color resist in the light-shielding region; and
wherein the thickness of the first pixel pattern, the second pixel pattern, the third pixel pattern and the light-shielding region are equal, so that the color resist layer surface is made planarization.
